(19) United States
(12) Patent Application Publication
(10) Pub. No.: US 2015/0242529 A1
(43) Pub. Date: Aug. 27, 2015

(54) Method for Interlacing Multiple Internet domain names with a Database Driven Website to Obtain Better Webpage Ranking on Major Search Engines by Executing Computer-Executable Instructions Stored On a Non-Transitory Computer-Readable Medium

(71) Applicant: Pradeep S. Kinger, South Daytona, FL (US)

(72) Inventor: Pradeep S. Kinger, South Daytona, FL (US)

(21) Appl. No.: 14/624,040

(22) Filed: Feb. 17, 2015

Related U.S. Application Data
(60) Provisional application No. 61/943,135, filed on Feb. 21, 2014.

(51) Int. Cl. G06F 17/30; H04L 29/08

(52) U.S. Cl. CPC G06F 17/30905; G06F 17/30867; G06F 17/30896; H04L 67/02

(57) ABSTRACT

A method of interlacing multiple internet domain names with a database driven website to obtain better webpage ranking on major search engines. This is accomplished by associating internet domain names on the server with designated URLs, which are either a virtual or a dynamic URL. Each designated URL of specific domain name is unique and is mapped to a webpage source code file. Upon user request to access a specific domain name, the designated URL of the specific domain name is parsed by webpage source code file to recognize URL attributes or keywords. Data relevant to the specific domain name is retrieved from the relational database based on the attributes recognized, and displayed on the website of the specific domain name. This allows a website offering multiple products or services to maintain specific domain names for specific products or services in order to achieve greater visibility on internet search engines.

The current application claims a priority to the U.S. Provisional Patent application Ser. No. 61/943,135 filed on Feb. 21, 2014.

### FIELD OF THE INVENTION

The present invention relates generally to connecting multiple internet domain names. More specifically, the present invention relates to interlacing multiple internet domain names with a database driven website.

### BACKGROUND OF THE INVENTION

Advertising is a form of marketing communication used to persuade an audience to take or continue some action, usually with respect to a commercial offering, or political or ideological support. Advertisers seek to generate increased consumption of their products or services in order to maintain or expand their business and generate revenue. One advertising venue that has grown significantly in recent years is the internet. Many businesses have taken advantage of the instant communication of the internet to educate and interface with potential and current customers and clients in order to run their business. Indeed, businesses with no internet presence are at a severe disadvantage due to the current ubiquity of the practice.

One important means for businesses to promote their brand and draw in attention and revenue to themselves is to engage in search engine optimization (SEO) practices on their website. SEO is the process of affecting the visibility of a website or a web page in a search engine's “natural” or unpaid. (“organic”) search results. In general, the earlier or higher ranked on the search results page a website appears, and the more frequently the website appears in the search results list, the more visitors it will receive from the search engine's users. SEO practices provide guidelines for website owners to optimize their websites for search engines and thus improve their ranking on search pages. In today's competitive market, SEO is more important than ever. Search engines serve millions of users per day looking online for answers to their questions, solutions to their problems or for products or services to purchase.

SEO can give business owners an advantage over the competition. If two websites are selling the same product or offering similar services, whichever website has better SEO management is more likely to appear to more users and therefore gain more customers and make more sales. The majority of search engine users are more likely to choose from the top five listings on a search page, so good SEO practices are essential to securing this coveted spot.

Search engines typically give visibility preference to industry giants. A large company's website is usually at the top of search result pages, while a smaller and less popular company is usually at the bottom of search result pages. This presents a problem for small business owners who are trying to survive in a competitive market. Since consumers are more likely to be presented with product and service pages associated with large, well-established companies, the small business suffers from a dearth of sales and must work very hard to stay afloat. A small hut reputable company selling a specific product is likely to lose the sale to a much larger company selling the exact same product. One solution to this problem is to purchase paid advertising on search engines, but this adds an extra burden to the small business's budget and is not fair, since they must pay extra to achieve the same level of exposure as larger companies. The large companies effortlessly rake in the profits while the small businesses struggle to stay alive making small profits as they are forced to spend large sums of money on online advertising. SEO can be used to bolster the small business's exposure, but it can be slow, time consuming and can also get expensive if the labor to put into place must be outsourced. Even then, a top position on search rankings can be transitory since websites must be optimized on a regular basis.

Currently, businesses typically operate a single internet domain name for listing all their products and services, and which typically reflects the name of the business. Research has found that search engines give preference to big companies and “keyword relevant internet domain names.” These are internet domain names which are directly relevant to search requests. For example, if a user performs a search for “Maytag dishwashers on sale,” the internet domain name “www.maytagdishwashersonsale” is given a much higher ranking on the search results pages than other domains with non-keyword relevant names, such as “www.joshandjessicaappliances.com,” due to the fact that the internet domain names containing matching keywords are considered to be more relevant to the user's search related terms.

Therefore, it is desirable for businesses to operate keyword relevant internet domain names for each product or service they offer. However, the greater number of products and services a business offers, the more time-consuming and difficult it is to set up and maintain keyword relevant internet domain names for each of the products and services. Therefore, it is the object of the present invention to provide a means for business owners to allow multiple internet domain names to be linked to the same database and website, thereby bypassing the need to have multiple different servers, emails, shopping carts, webpage designs, and so on. Instead of having one main website with multiple subcategories for each product or service, each product or service could have its own domain. Thus, one website can be interlaced with multiple keyword relevant domains, allowing the business to increase exposure for their products or services and to build and grow their business online.

### BRIEF DESCRIPTION OF THE DRAWINGS

FIG. 1 is a visualization of the relational database and its contents examples of individualized domain names.

FIG. 2 is a visualization of the centralized architecture of the relational database enabling multiple domain names to be created from a single database.

FIG. 3 is a visualization of an analogy for the present invention.

FIG. 4 is a visual flow diagram depicting a general overview of the present invention.

FIG. 5 is an example of relational data items in the database.

FIG. 6 is another example of relational data items in the database including keywords and SEC) parameters.

FIG. 7 is another example of relational data items in the database including titles and descriptions for various domain names.

FIG. 8 is an example web page showing geospatially contextual links.

FIG. 9 is an example web page showing an example of a dynamically configurable webpage header.

FIG. 10 is a stepwise flow diagram depicting the general process of the present invention.

FIG. 11 is a stepwise flow diagram depicting processes for defining a designated URL.

FIG. 12 is a stepwise flow diagram depicting a process for finding and displaying relevant relational data items from a designated URL.

FIG. 13 is a stepwise flow diagram depicting steps for initializing the domain names and contextually configuring webpages for the domain names.

FIG. 14 is a stepwise flow diagram depicting processes for dynamically configuring geospatially relevant keywords for relevant domain names.

FIG. 15 is a stepwise flow diagram depicting a process for formatting URLs for search engine visibility.

FIG. 16 is a stepwise flow diagram depicting the process for dynamically configuring a webpage header template based on search parameters.

FIG. 17 is a stepwise flow diagram depicting the process for customizably displaying advertisements on the domain names.

FIG. 18 is a stepwise flow diagram depicting the process for configuring an email communication system which can interface with any of the domain names.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced without the implementation of some features as they are described. It should be understood that some details have not been described in detail in order to not unnecessarily obscure focus of the invention.

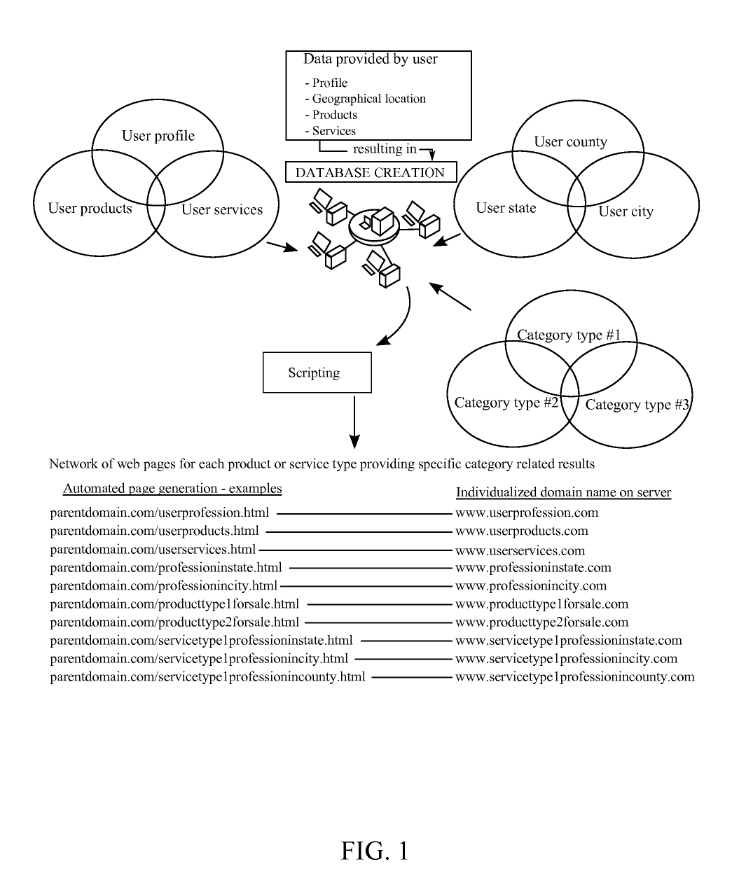

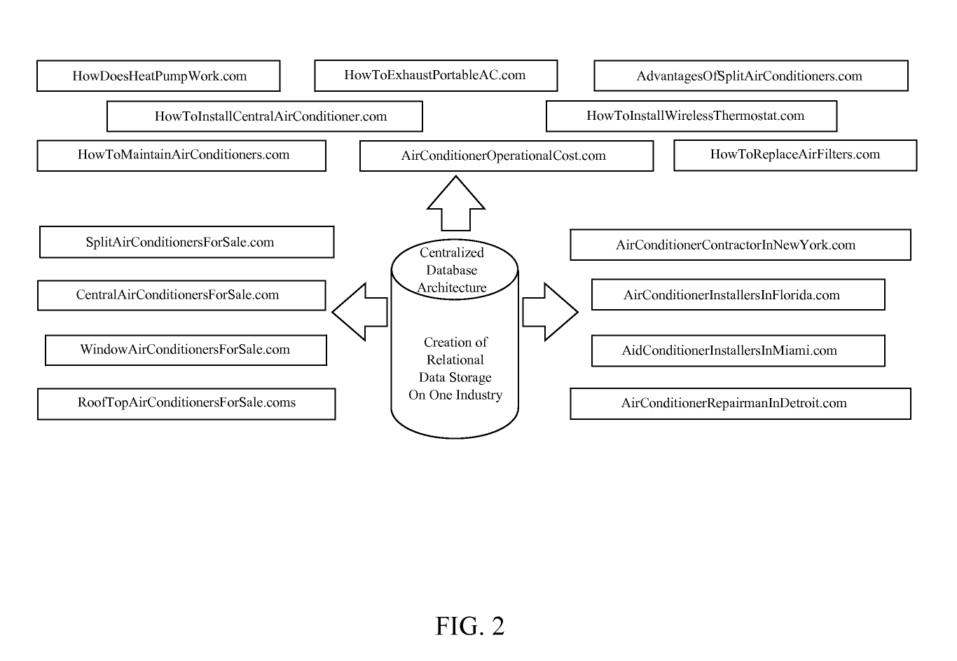

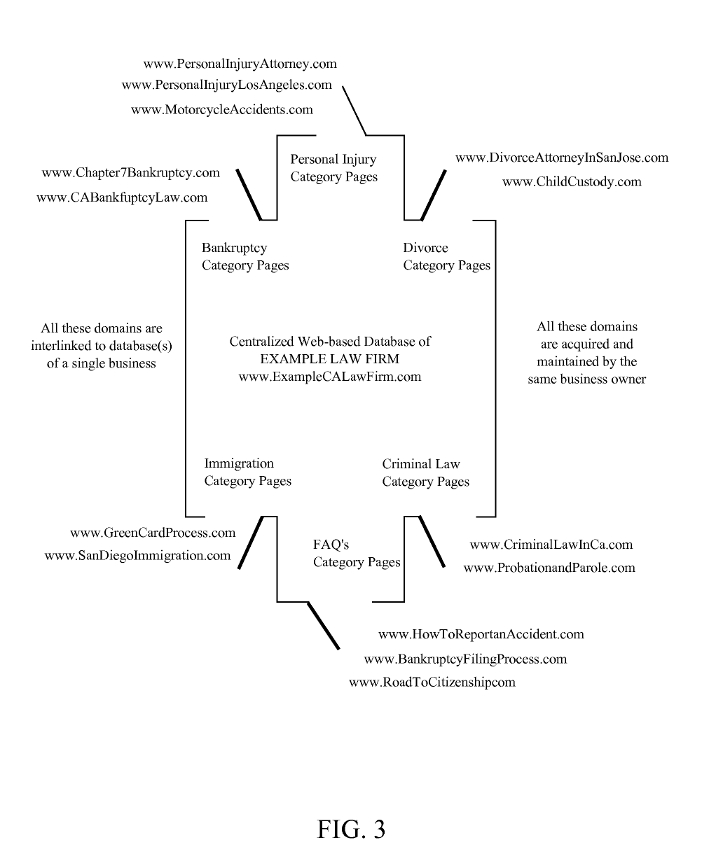

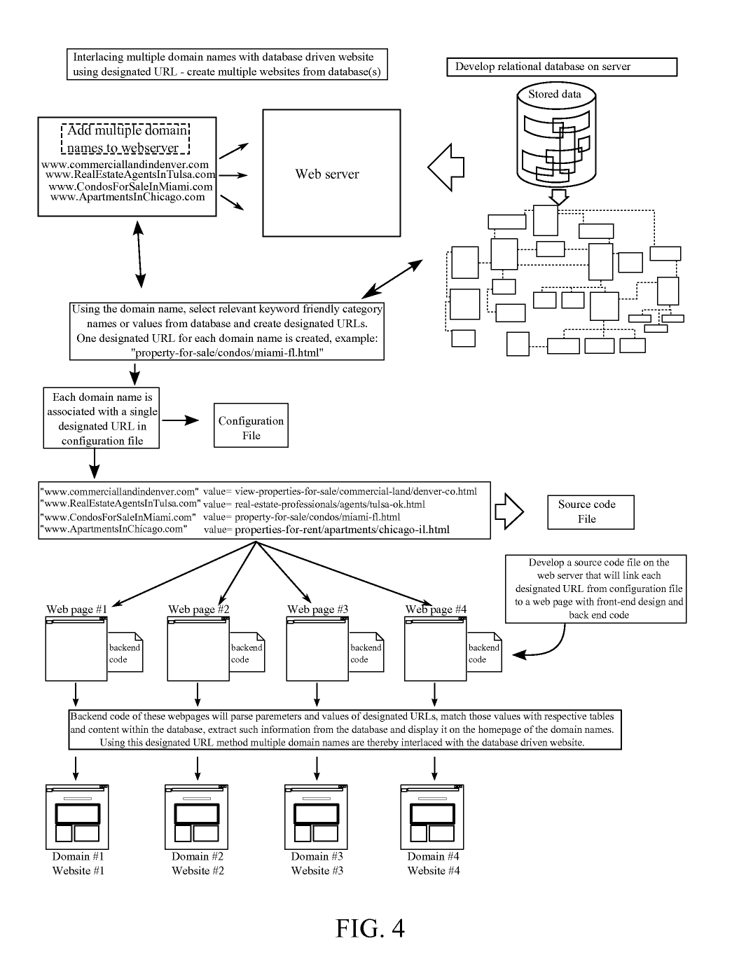

The present invention is a method for interlacing multiple internet domain names with a database driven website (or simply “website”) in order to serve the website with multiple domains. This enables the website to provide specific internet domain name names to keyword friendly strategic pages, mainly relevant to categories and subcategories in order to achieve greater visibility in search engine listings. Graphic visualizations of the present invention is provided in FIGS. 1-3. FIG. 1 illustrates how users can enter their information with a variety of attributes into a database in order to be listed on the domains managed by the database, web-server, and associated scripts and programming logic. Individual pages, categories or subcategories of the website may be managed as individualized internet domain names according to the relevant searched keyword term. FIG. 2 provides a similar illustration showing how centralized database architecture and creation of relational data storage for one industry can support multiple specialized internet domain names for that industry. In reference to FIG. 3, the present invention may also be understood by an analogy of a large room or warehouse (representing the database) containing multiple categories of products or services. The present invention seeks to add additional “doors” into the warehouse in the form of specialized internet domain names linking to associated content within the database. Multiple domains may be interlaced conjointly with a single database or multiple databases of the same business to extract and display relevant information online pertaining to a particular category the business deals in. A user may be able to go from one domain representing one category to another domain representing another category, while still remaining connected to the same business's database in the back-end. A graphical overview of the present invention is presented in FIG. 4.

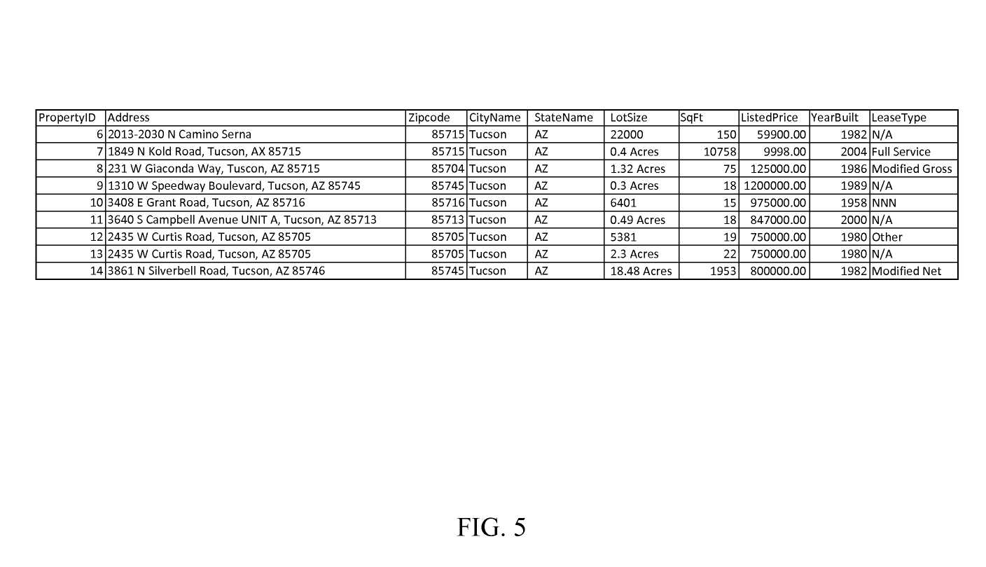

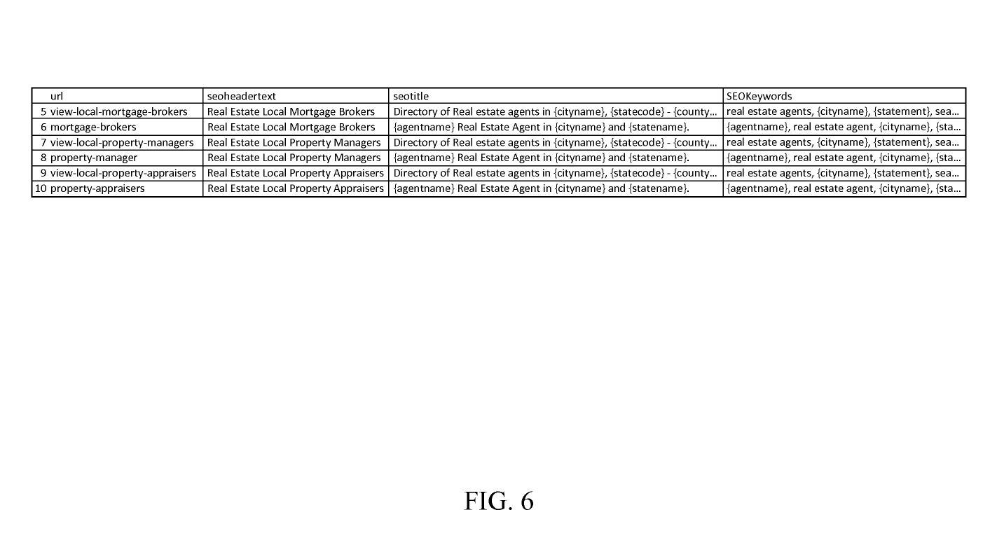

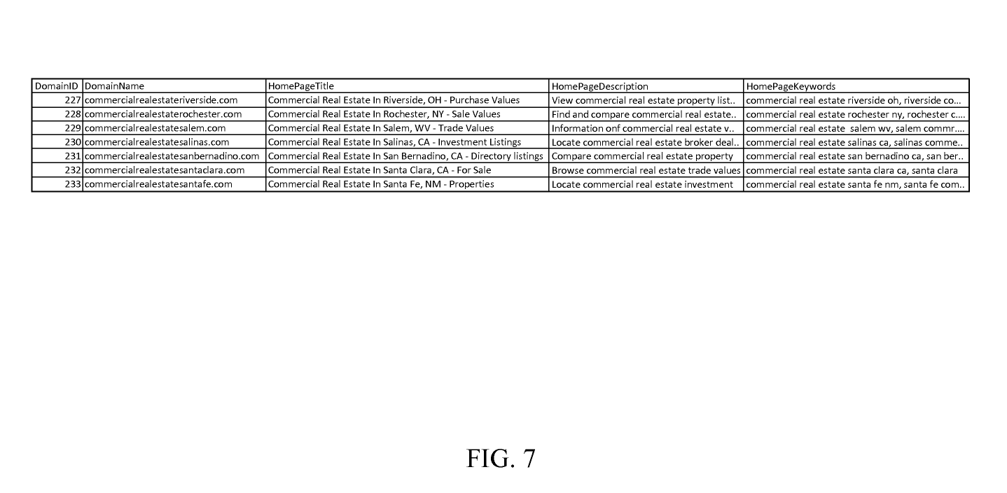

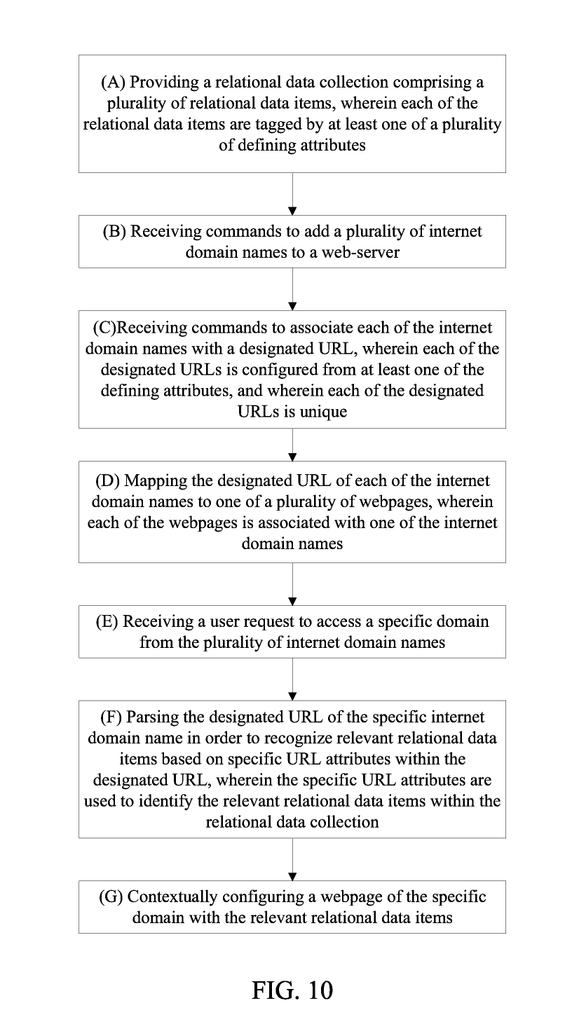

Referring to FIG. 10, in the general process of the present invention, a relational data collection comprising a plurality of relational data items is provided. The relational data items are text values in the form of fields, columns, and rows contained in a relational database. Each of the relational data items is associated with at least one of a plurality of defining attributes. Each of the plurality of defining attributes is understood to be a single data item within a field, a column or a row within the relational database. The relational data items represent whatever fundamental unit of data is to be contained in the database and provided to a website by a web-server, database or another relevant domain management entity. In general, the relational data items are collections of data from various relevant combinations of fields, columns, and/or rows with pieces of data, records, or text values within table cells. Examples of relational data items are shown in FIGS. 5-7.

The defining attributes are utilized to organize the relational data items in order to locate and distribute relevant data. An example of a relational data item may be a collection of information about a real estate agent, such as the agent's name, phone number, mailing address, location, and services provided. Examples of defining attributes associated with the real estate agent may include location (Miami, Fla. for example) and type of real estate represented (apartments and condominiums, for example). In the present invention, the example real estate agent may be found by performing a search for one or more of the defining attributes—by searching for real estate agents in Miami representing apartments, for example.

Initially, a programmer, administrator, developer, coder, software engineer or other type of management personnel of the present invention performs various actions in order to initialize the present invention. Hereinafter, any such person who is allowed access to manage any portion of the website, internet domain names, server or web-server is referred to as a website administrator. A plurality of internet domain names are purchased and manually added to the server; the web-server receives commands to add the plurality of internet domain names to a list of managed domains on the web-server. More specifically, each of the plurality of internet domains is configured to a domain name service (DNS) server, and subsequently commands are further received to add the internet domain names to the web-server. Commands are then received to associate each of the internet domain names with a designated URL. The designated URL is a URL compiled manually or configured dynamically from the relational data items or defining attributes within the relational database. For each of the plurality of internet domain names, the associated designated URL is unique among the designated URLs, and is configured from at least one of the defining attributes or relational data items. The designated URL may be configured from the defining attributes, the relational data items, or both. Subsequently, the designated URL of each of the internet domain names is mapped to one of a plurality of webpages, wherein each of the webpages is associated with one of the internet domain names. More specifically, the designated URL of each of the internet domain names is mapped to the web page source code template file of one of the plurality of webpages. The webpage source code template file is a webpage that has a backend script made with any desirable programming language. The web page source code template file of each of the internet domain names is developed to parse the designated URL of the associated domain name and produce a relevant webpage from relevant relational data items using any relevant programming language. The web page source code template file associated with each of the internet domain names is developed to parse the designated URL of the associated internet domain and produce a relevant webpage through any relevant programming techniques in any desired programming language.

In the preferred embodiment, the defining attributes are words or combinations of words indicating a concept significant for identifying one of the plurality of internet domain names. For example, if the specific internet domain name is “www.ApartmentsinNY.com,” an example of a defining attribute for the specific internet domain name might be “Apartments in New York” or “apartments-in-new-york.” It should be noted that the defining attributes are not limited in form to a single word, but may take the form of multiple words, numbers or other characters linked together, which form a descriptive identification representing all of the relational data items which are associated with the relevant attribute. However, in alternate embodiments, one or more of the defining attributes may take a form which is not directly representative of a word, such as a string of unrelated characters or numbers.

A single relational data item may be associated with multiple defining attributes, and a single defining attribute may tag multiple relational data items. For example, “Example apartment listing A,” “Example apartment listing B,” and “Example apartment listing C” are all associated with the attributes “properties-for-rent” and “apartments,” while the attribute “miami-fl” tags “Example apartment listing A” and “Example apartment listing C” but not “Example apartment listing B,” which is instead associated with the attribute “orlando-florida.”

When an end-user accesses a specific internet domain name from the plurality of internet domain names, a user request is received by the web-server to access the specific internet domain name. The designated URL of the specific internet domain name is parsed using its associated webpage source template file of the webpage associated with the specific internet domain name in order to recognize relevant relational data items from the plurality of relational data items. The relevant relational data items are recognized based on specific URL attributes within the designated URL. The specific URL attributes are used to identify the relevant relational data items within the relational database. In most or all cases, the specific URL attributes are each a string of alphabetical, numerical or alphanumeric characters, symbols, or other characters.

A website of the specific internet domain name is then contextually configured with the relevant relational data items. In other words, the purpose of the specific internet domain name is to display information related to the defining attributes from which the designated URL of the specific internet domain name is configured. The relational database is searched to recognize relevant attributes which match the specific URL attributes, and the relevant relational data items associated with the relevant attributes are retrieved.

Once the relevant attributes are found, any relational data items associated with the relevant attributes are retrieved from the database and displayed on the webpage of the specific internet domain name. Thus, a large number of internet domain names representing various different combinations of attributes may be served by the same web-server and the same database. For example, the internet domain name “housesforrentinchicago.com” might be one of the plurality of internet domain names. Some of the keywords for said domain might include keywords such as “real estate for rent,” “houses,” “Chicago,” and “Illinois.” Another example domain “mortgagebrokersinlexingtonky.com” might include the keywords “mortgage-company-for-hire,” “brokers,” “Lexington,” and “Kentucky.”

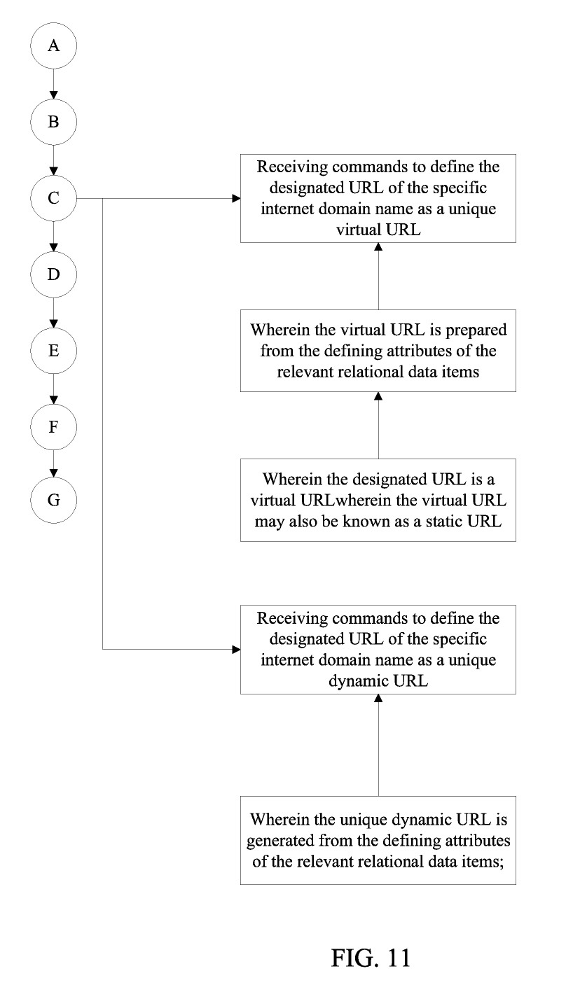

Referring to FIG. 11, in one embodiment of the present invention, in order to define the designated URL, commands are received to define the designated URL of the specific internet domain name as a unique virtual URL, which is unique from any other designated URL associated with other internet domain names from the plurality of internet domain names which are not the specific internet domain name. The unique virtual URL of the specific internet domain name is prepared from the defining attributes of the relevant relational data items. In this embodiment, the unique virtual URL may alternatively be known as a static URL. Each of the plurality of internet domain names is associated with one unique virtual URL. The unique virtual URL for each internet domain name is manually designated by the website administrator within a website configuration file or domain configuration file of the server. The website administrator chooses the defining attributes according to the specific purpose of the specific internet domain name. The defining attributes chosen by the website administrator for the unique virtual URL are manually chosen from the plurality of defining attributes in the relational database, which are pre-defined. For example, if the specific internet domain name is “www.CommercialLandInDenver.com,” the website administrator will define the unique virtual URL as “view-properties-for-sale/commercial-land/denver-co.html.” Once the specific internet domain name is accessed, a web-server program will recognize the defining attributes in the unique virtual URL, and display the relevant information accordingly using a web page source code template file for the homepage of the specific internet domain name. The web page source code template file is described later herein.

In another embodiment, commands are received to define the designated URL as a unique dynamic URL. Similar to the unique virtual URL, the unique dynamic URL is unique from the designated URLs of any other internet domain names from the plurality of internet domain names. The unique dynamic URL is generated from the defining attributes of the relevant relational data items, and any additional parameters or attributes as necessary based on the nature of the specific internet domain name. For example, to generate the dynamic URL, the website administrator enters one or more keywords into a search page, which is connected to the database and can search through the database to find relevant relational data items. The search page dynamically generates a search results page for the keywords, and the unique dynamic URL for the search results page is generated according to a predefined programming logic. Alternatively, a dynamic URL creation script, program or code may be developed in any relevant programming language in order to generate the unique dynamic URL. The dynamic URL creation script will use the defining attributes of the relevant relational data items to create a unique dynamic URL from the database. The dynamic URL creation script may utilize any number of different methods to generate the unique dynamic URL as desired. An example of a unique dynamic URL is as follows, but is not limited to: “www.examplewebsite.com/SalesSearchResultaspx?PropertyType=condo?State=fl&city=tampa.” Such dynamically generated URLs are designated to internet domain names in the website configuration file, similarly to the previous description of utilizing virtual URLs. The website configuration file may also be known as the domain name configuration file. Once the specific internet domain name is accessed, a web-server program will recognize and display the relevant web page source code template file of that respective internet domain name, which will further read the attributes within the dynamic URL and display relevant relational data items accordingly.

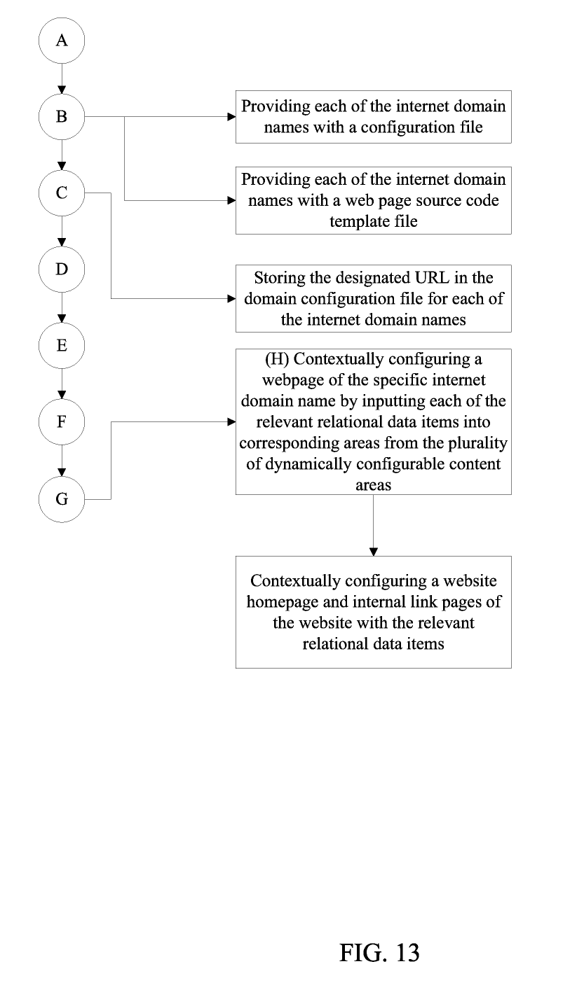

Referring to FIG. 13, in the preferred embodiment of the present invention, each of the internet domain names has predefined settings which are provided within a configuration file. The configuration file may either be a domain configuration file or a website configuration file, as appropriate for the specific application. Preferably, the designated URL is stored in the domain configuration file (or website configuration file) for each of the internet domain names, though it is possible that in alternate embodiments the designated URL is stored in another location.

Each of the internet domain names is additionally provided with a web page source code template file. The web page source code template file should be understood to be a web page with back-end scripts or source code made from any programming language. The web page source code template file includes a plurality of dynamically configurable content areas. The dynamically configurable content areas are sections or areas of a webpage where content of the website is displayed. Any given webpage may have one or more dynamically configurable content areas. When displaying a webpage of the website of the specific internet domain name, the webpage is contextually configured by inputting each of the relevant relational data items into a corresponding dynamically configurable area from the plurality of dynamically configurable content areas.

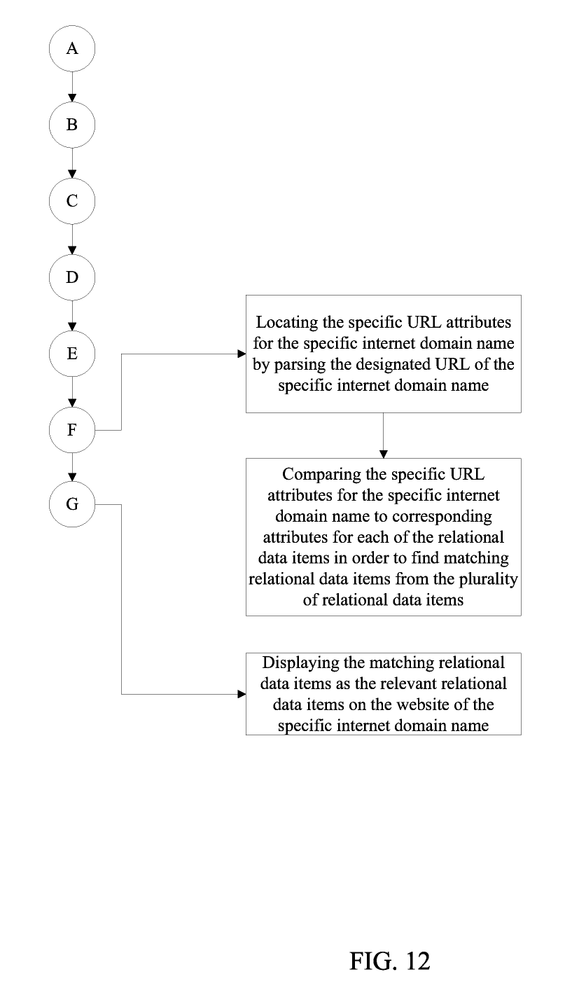

As shown in FIG. 12, in order to dynamically generate the webpage of the specific internet domain name, each of the specific URL attributes is located by parsing the designated URL of the specific internet domain name using a URL parsing algorithm which is pre-defined by the website administrator. The specific URL attributes for the designated URL of the specific internet domain name are compared to corresponding attributes for each of the relational data items in order to find matching relational data items from the plurality of relational data items within the database. It should be noted that references to the database herein may refer to a single database or multiple databases linked together or to which the present invention is granted access. The matching relational data items are then displayed as the relevant relational data items within the webpage.

The preferred embodiment of the present invention additionally includes several search engine optimization (SEO) techniques that can be utilized in conjunction with or as an application of the present invention to further accomplish the purpose of the present invention of achieving greater search engine visibility for one or more of the plurality of internet domain names of the database driven website.

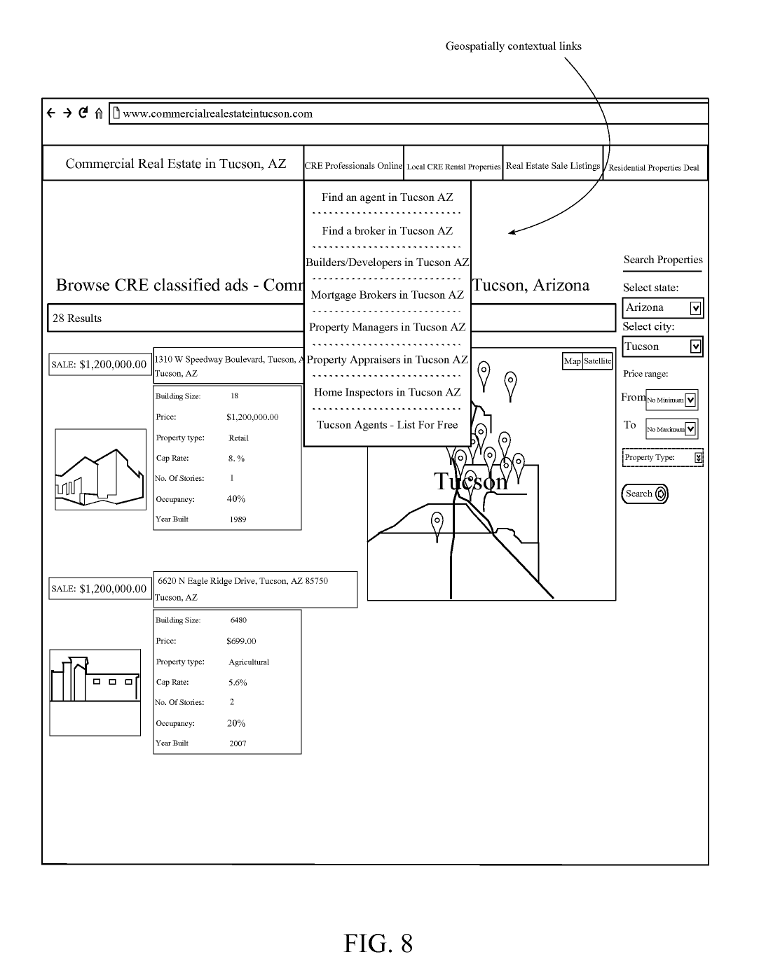

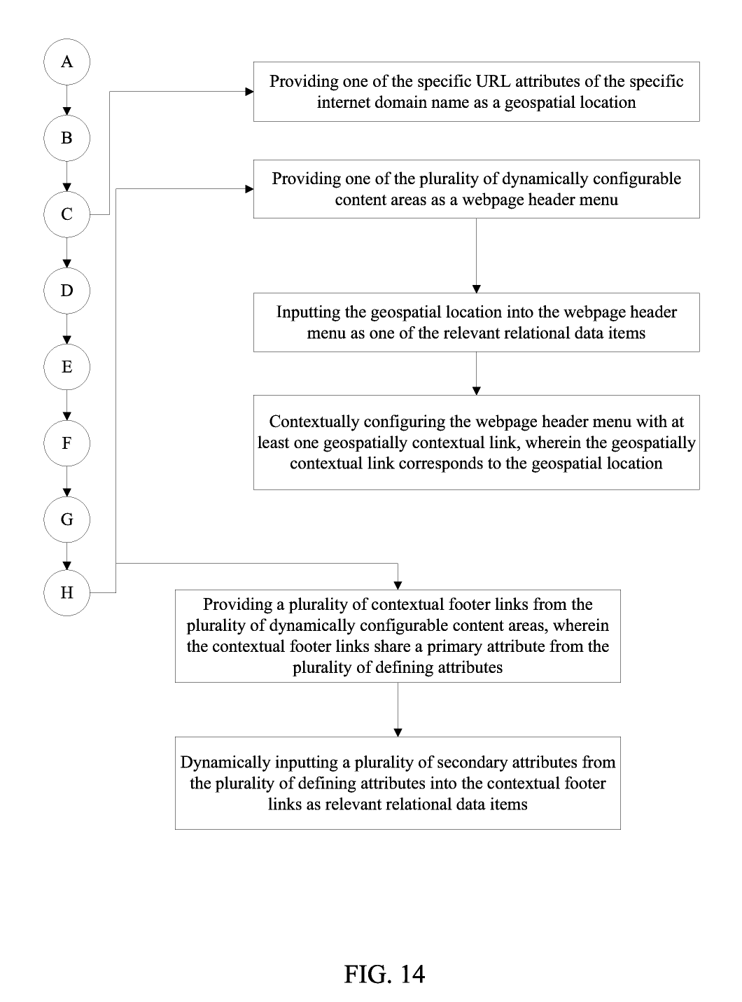

One SEO technique of the present invention is to dynamically generate location relevant links on the webpage of each of the plurality of internet domain names, as relevant. To this end, one of the specific URL attributes of the designated URL of the specific internet domain name is provided as a geospatial location, as depicted in FIG. 14. In other words, the geospatial location associated with the specific internet domain name is provided using one of the specific URL attributes. The specific internet domain name is referenced herein as belonging to the plurality of internet domain names as an example of a singular application, but the process may be applied to any of the internet domain names as applicable or desired. One of the plurality of dynamically configurable content areas of the web page source code template file of the specific internet domain name is provided as a webpage header menu. More specifically, in the preferred embodiment the webpage header menu is contextually configured with at least one geospatially contextual link, wherein the geospatially contextual link corresponds to the geospatial location. An example can be seen in FIG. 8.

The geospatial location is inputted into the webpage header menu as one of the relevant relational data items. The geospatial location of the specific internet domain name may differ from the geospatial location of other domains from the plurality of internet domain names. Thus, the specific internet domain name gains greater visibility when an end-user performs a search for whatever service or product the specific internet domain name is offering when the end-user searches for the product or service around the end-user's location, which corresponds to the geospatial location keyword of the specific internet domain name.

For example, the internet domain name “CommercialRealEstatelnTucson.com” will show header links “Real Estate Agents In Tucson, Ariz.” and “Office Buildings In Tucson, Ariz.”, while the invention will provide internet domain name “RealEstateInDallas.com” with relevant header links such as “Real Estate Agents In Dallas, Tex.” and “Office Buildings In Dallas, Tex.” and “Apartments In Dallas, Tex.” thereby making the headers unique and search engine friendly, in addition to providing ease of browsing to the consumer/user who is only interested in that specific geospatial location.

In a similar fashion, a plurality of contextual footer links may be provided on one of more of the internet domain names of the database driven website, wherein the plurality of contextual footer links are comprised by the plurality of dynamically configurable content areas, and wherein the contextual footer links share a primary attribute from the plurality of defining attributes within the relational data collection. A plurality of secondary attributes are inputted from the plurality of defining attributes into the contextual footer links as relevant relational data items from the relational data collection. Alternatively stated, the relevant relational data items that are inputted into the contextual footer links share the primary attribute, and are associated with at least one secondary attribute. For example, the primary attribute may be real estate, while the secondary attributes represent categories related to real estate—apartment, townhouse, condominium, and real estate agent, for example. So if the geospatial location of the specific internet domain name is Houston, Tex., and the primary attribute of the contextual footer links is related to real estate, an example of three of the contextual footer links would include “Apartments in Houston,” “Townhouses in Houston,” “Condominiums in Houston,” and “Real Estate Agents in Houston.”

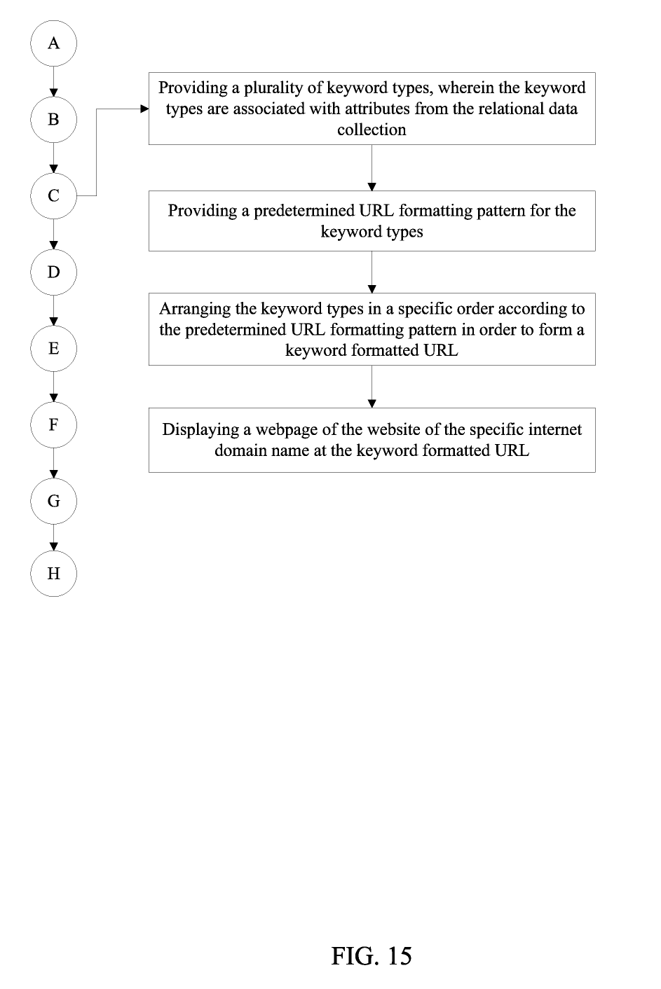

In reference to FIG. 15, another SEO technique comprised in the preferred embodiment of the present invention is to integrate pre-defined patterns into the URLs of each of the internet domain names of the present invention. To this end, a plurality of keyword types are provided, wherein the keyword types are associated with attributes from the relational data collection. Additionally, a predetermined URL formatting pattern is provided for the keyword types. The keyword types are then arranged in a specific order according to the predetermined URL formatting pattern in order to form a keyword formatted URL. For example, the predetermined URL formatting pattern might specify that a state name keyword from the domain relevant keywords is positioned within the URL before a city name keyword from the domain relevant keywords of the specific internet domain name, or vice versa. A webpage of the website of the specific internet domain name is then displayed at the keyword formatted URL.

For example, using a desired programming language, the website administrator will predefine URL patterns for the example internet domain name www.commercialrealestateinusa.com. For example—in this case, URL Pattern A—“home-rentals” and URL pattern B—“cityname-statecode” will be generated for any page that is relevant to the attribute “Home For Rent”. Similarly, for the example internet domain name www.commercialrealestatelistings.com with the same attribute, URL Pattern A in this case will be—“houses-for-rent” and URL Pattern B in this case will be—“statename-cityname.” These URL patterns will be predefined. Based on this SEO technique, above internet domain name urls will show up as: www.commercialrealestateinusa.com/home-rentals/dallas-tx.html and www.commercialrealestatelistings.com/houses-for-rent/texas-dallas.html respectively for the same attribute making the URLs unique for each of the plurality of internet domain names.

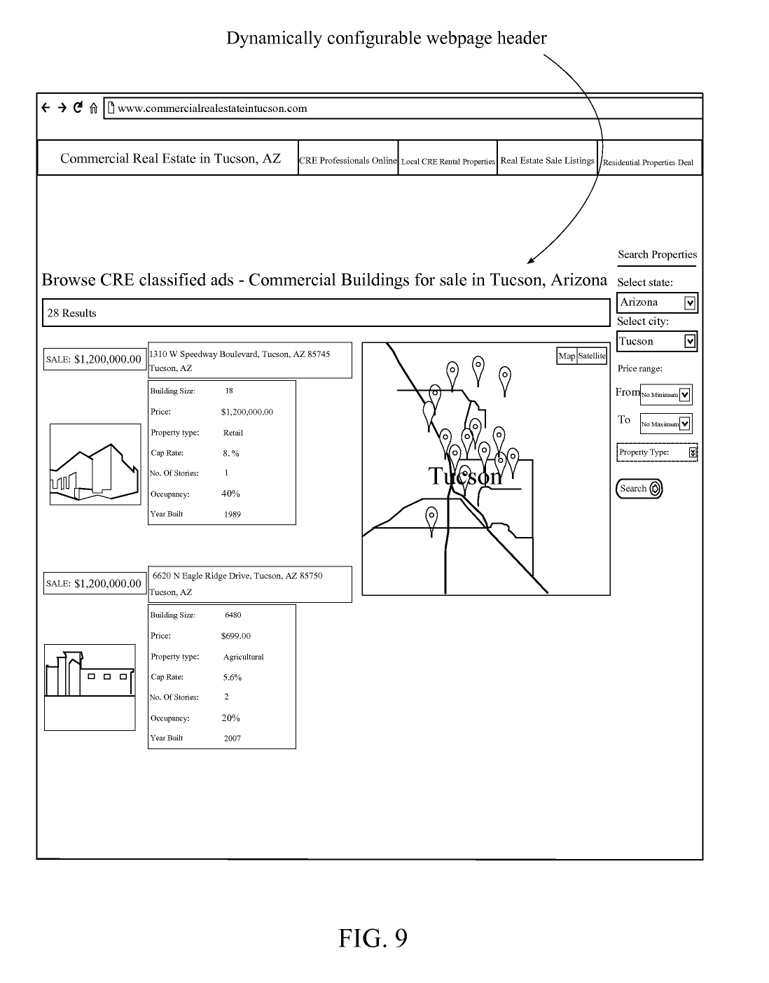

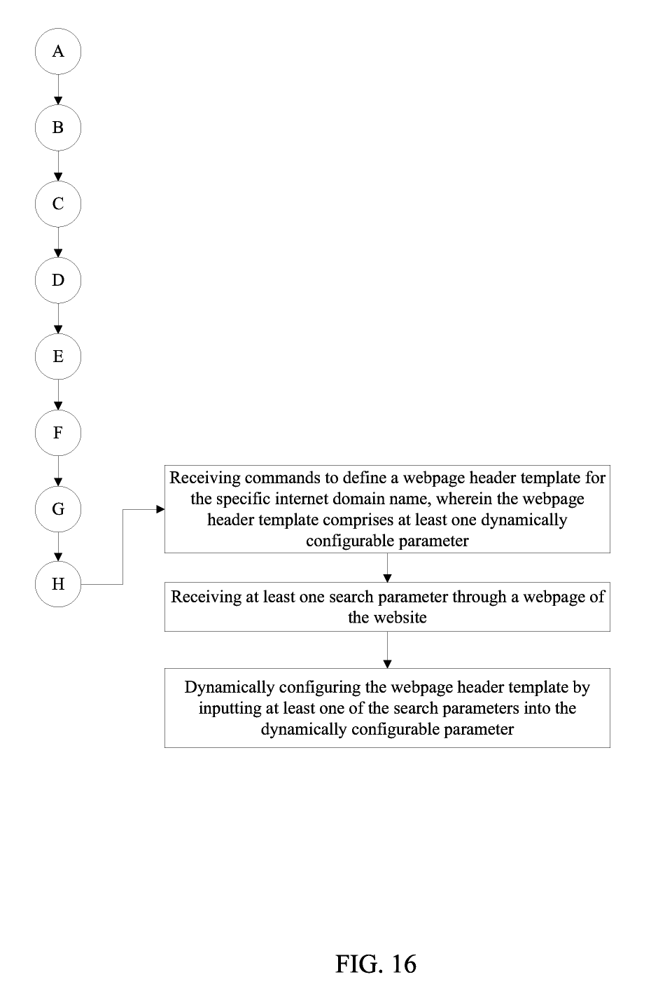

Additionally, it is preferable to dynamically configure webpage header or title sections on the webpage of the specific internet domain name and each of the plurality of internet domain names. The webpage header of a webpage is recognized with a higher priority than many other typical sections of a web site by search engines, and thus it is desired to dynamically configure the webpage header of each of the plurality of internet domain names in order to achieve maximum search engine visibility. This is particularly true for websites which provide a search function, so that the webpage header may be dynamically configured according to whatever parameters an end user wishes to search for. To this end, commands are received by the source code file of the webpage to define a webpage header template for the specific internet domain name, wherein the webpage header template comprises at least one dynamically configurable parameter, as depicted in FIG. 16. At least one search parameter is received through a webpage of the website, and the webpage header template is configured by inputting at least one of the search parameters into the dynamically configurable parameter. An algorithm may be provided to determine which of the inputted search parameters may be inputted into the webpage header template. For example, geospatial location and a primary search parameter such as real estate listing or business type may be prioritized. An example of this is shown in FIG. 9.

For example: An example page header “Houses For Rent In Dallas, Tex.” is dynamically generated using configurable parameters such as “(property type) For Rent in (cityname), (statname)” for one internet domain name, while the same page on another internet domain name will open with the page header as “Rental Homes in Dallas, Tex.” with configurable parameter such as “Rental (property type) in (cityname), (statecode),” thereby making headers unique on each of the plurality of internet domain names.

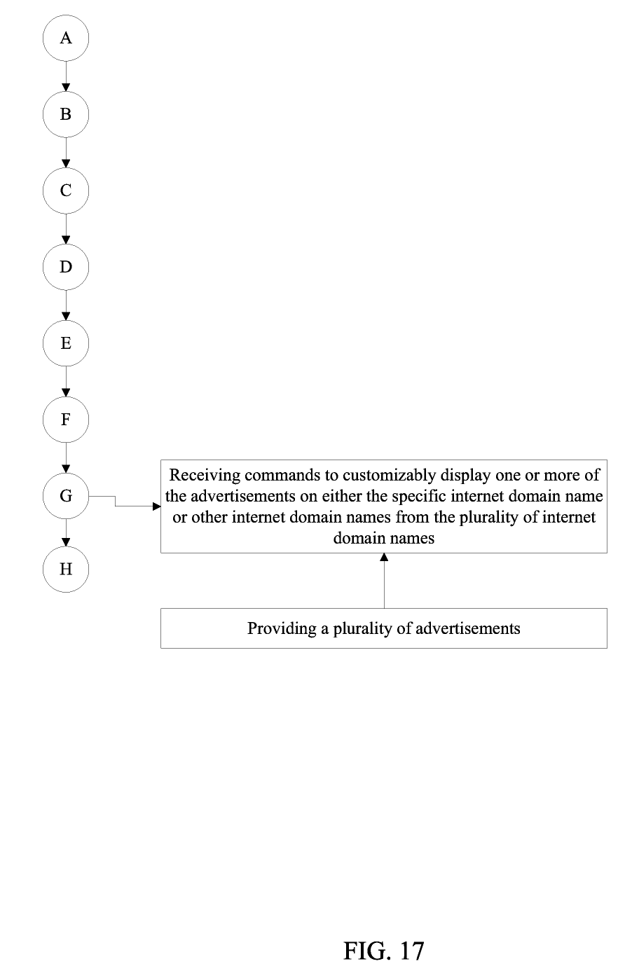

Furthermore, referring to FIG. 17, a plurality of advertisements may be provided. Commands are then received to customizably display one or more of the advertisements on either the specific internet domain name or other domain names from the plurality of internet domain names according to parameters or other settings defined by the website administrator.

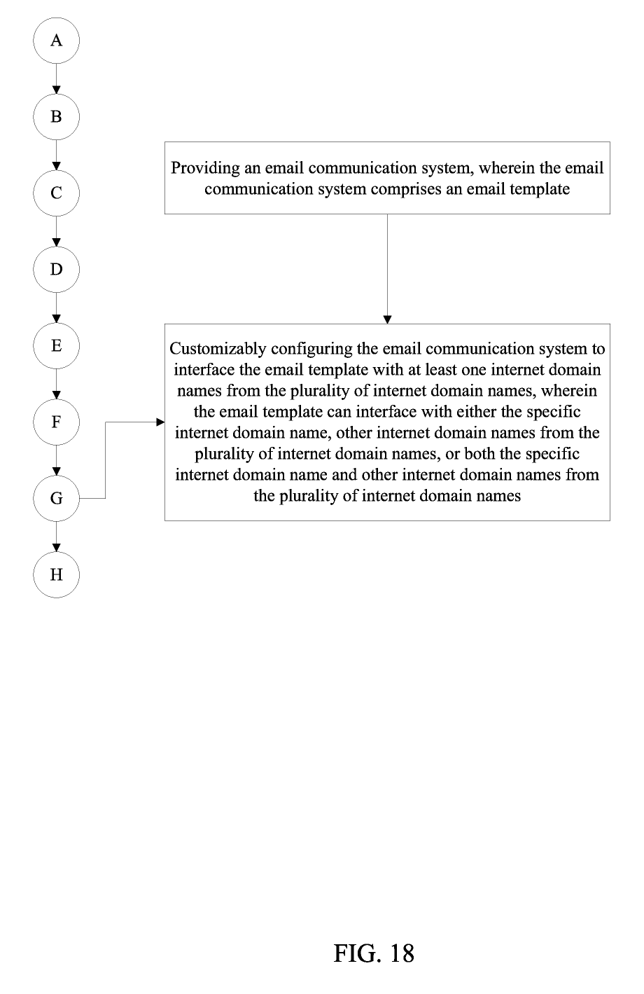

Another feature comprised in the preferred embodiment of the present invention is an email communication system comprising an email template, as shown in FIG. 18. The email communication system may be customizably configured to interface the email template with at least one domain from the plurality of internet domain names. The email template can interface with either the specific internet domain name, other domains from the plurality of internet domain names, or both the specific internet domain name and other domains from the plurality of internet domain names. The website administrator may send commands through an administrator panel to customize the email communication system and choose any preferred combination of domains to interface the email communication system with.

Although the invention has been explained in relation to its preferred embodiment, it is to be understood that many other possible modifications and variations can be made without departing from the spirit and scope of the invention as hereinafter claimed.

What is claimed is:

1. A method for interlacing multiple internet domain names with a database driven website to obtain better webpage ranking on major search engines by executing computer-executable instructions stored on a non-transitory computer-readable medium comprises the steps of:
providing a relational data collection comprising a plurality of relational data items, wherein the relational data items are text values in the form of fields, columns, and rows contained in a relational database, and wherein each of the relational data items are associated with at least one of a plurality of defining attributes;
receiving commands to add a plurality of internet domain names to a web-server;
receiving commands to associate each of the internet domain names with a designated URL, wherein the designated URL for each of the internet domain names is configured from at least one of the defining attributes or relational data items, and wherein the designated URL for each of the internet domain names is unique;
mapping the designated URL of each of the internet domain names to the web page source code template file of one of a plurality of webpages, wherein each of the web page source code template files is associated with one of the internet domain names, and wherein each of the web page source code template files is developed to parse the designated URL of the associated internet domain name using a programming language and produce a relevant webpage from relevant relational data items
receiving a user request to access a specific internet domain name from the plurality of internet domain names;
parsing the designated URL of the specific internet domain name in order to recognize relevant relational data items based on specific URL attributes within the designated URL, wherein the relevant relational data items are from the plurality of relational data items, and wherein the specific URL attributes are used to identify the relevant relational data items within the relational database; and
contextually configuring a website of the specific internet domain name with the relevant relational data items.

2. The method of interlacing multiple internet domain names with a database driven website to obtain better webpage ranking on major search engines by executing computer-executable instructions stored on a non-transitory computer-readable medium as claimed in claim 1 comprises the step of:
receiving commands to configure the designated URL of the specific internet domain name as a unique virtual URL, wherein the unique virtual URL is unique from the designated URLs of other internet domain names from the plurality of internet domain names, wherein the unique virtual URL is prepared from the defining attributes of the relevant relational data items, and wherein the virtual URL may also be known as a static URL.

3. The method of interlacing multiple internet domain names with a database driven website to obtain better webpage ranking on major search engines by executing computer-executable instructions stored on a non-transitory computer-readable medium as claimed in claim 1 comprises the step of:
receiving commands to configure the designated URL of the specific internet domain name as a unique dynamic URL, wherein the unique dynamic URL is unique from the designated URLs of other internet domain names from the plurality of internet domain names, and wherein the unique dynamic URL is generated from defining attributes within the relational database.

4. The method of interlacing multiple internet domain names with a database driven website to obtain better webpage ranking on major search engines by executing computer-executable instructions stored on a non-transitory computer-readable medium as claimed in claim 1 comprises the steps of:
providing each of the internet domain names with a configuration file, wherein the configuration file is either a domain configuration file or a website configuration file; and
storing the designated URL in the domain configuration file for each of the internet domain names.

5. The method of interlacing multiple internet domain names with a database driven website to obtain better webpage ranking on major search engines by executing computer-executable instructions stored on a non-transitory computer-readable medium as claimed in claim 1 comprises the steps of:
providing each of the internet domain names with a web page source code template file, wherein the web page source code template file is a webpage with backend scripts made from any programming language, and wherein the web page source code template file includes a plurality of dynamically configurable content areas; and
contextually configuring a webpage of the specific internet domain name by inputting each of the relevant relational data items into corresponding dynamically configurable areas from the plurality of dynamically configurable content areas.

6. The method of interlacing multiple internet domain names with a database driven website to obtain better webpage ranking on major search engines by executing computer-executable instructions stored on a non-transitory computer-readable medium as claimed in claim 1 comprises the steps of:
locating the specific URL attributes for the specific internet domain name by parsing the designated URL of the specific internet domain name;
comparing the specific URL attributes for the specific internet domain name to corresponding attributes for each of the relational data items in order to find matching relational data items from the plurality of relational data items; and
displaying the matching relational data items as the relevant relational data items on the website.

7. The method of interlacing multiple internet domain names with a database driven website to obtain better webpage ranking on major search engines by executing computer-executable instructions stored on a non-transitory computer-readable medium as claimed in claim 1 comprises the step of:
contextually configuring a website homepage and internal link pages of the website with the relevant relational data items.

8. The method of interlacing multiple internet domain names with a database driven website to obtain better webpage ranking on major search engines by executing computer-executable instructions stored on a non-transitory computer-readable medium as claimed in claim 7 comprises the steps of:
providing one of the specific URL attributes of the specific internet domain name as a geospatial location, wherein the specific internet domain name is from the plurality of internet domain names, and wherein the geospatial location is a domain relevant keyword to the specific domain;
providing one of the plurality of dynamically configurable content areas as a webpage header menu; and
inputting the geospatial location into the webpage header menu as one of the relevant relational data items, wherein the geo spatial location of the specific internet domain name may differ from the geospatial location of other domains from the plurality of internet domain names, and wherein the geospatial location displayed in the webpage header menu dynamically changes based on which of the internet domain names or domain relevant keywords the webpage header menu is displayed with.

9. The method of interlacing multiple internet domain names with a database driven website to obtain better webpage ranking on major search engines by executing computer-executable instructions stored on a non-transitory computer-readable medium as claimed in claim 8 comprises the step of:
contextually configuring the webpage header menu with at least one geospatially contextual link, wherein the geospatially contextual link corresponds to the geospatial location.

10. The method of interlacing multiple internet domain names with a database driven website to obtain better webpage ranking on major search engines by executing computer-executable instructions stored on a non-transitory computer-readable medium as claimed in claim 7 comprises the step of:
providing a plurality of contextual footer links from the plurality of dynamically configurable content areas, wherein the contextual footer links share a primary attribute from the plurality of defining attributes within the relational data collection; and
dynamically inputting a plurality of secondary attributes from the plurality of defining attributes into the contextual footer links as relevant relational data items from the relational data collection.

11. The method of interlacing multiple internet domain names with a database driven website to obtain better webpage ranking on major search engines by executing computer-executable instructions stored on a non-transitory computer-readable medium as claimed in claim 1 comprises the step of:
providing a plurality of keyword types, wherein the keyword types are associated with attributes from the relational data collection;
providing a predetermined URL formatting pattern for the keyword types;
arranging the keyword types in a specific order according to the predetermined URL formatting pattern in order to form a keyword formatted URL; and
displaying a webpage of the website of the specific internet domain name at the keyword formatted URL.

12. The method of interlacing multiple internet domain names with a database driven website to obtain better webpage ranking on major search engines by executing computer-executable instructions stored on a non-transitory computer-readable medium as claimed in claim 1 comprises the step of:
receiving commands to define a webpage header template for the specific internet domain name, wherein the webpage header template comprises at least one dynamically configurable parameter;
receiving at least one search parameter through a webpage of the website; and
dynamically configuring the webpage header template by inputting at least one of the search parameters into the dynamically configurable parameter.

13. The method of interlacing multiple internet domain names with a database driven website to obtain better webpage ranking on major search engines by executing computer-executable instructions stored on a non-transitory computer-readable medium as claimed in claim 1 comprises the step of:
providing a plurality of advertisements; and
receiving commands to customizably display one or more of the advertisements on either the specific internet domain name or other domains from the plurality of internet domain names.

14. The method of interlacing multiple internet domain names with a database driven website to obtain better webpage ranking on major search engines by executing computer-executable instructions stored on a non-transitory computer-readable medium as claimed in claim 1 comprises the step of:
providing an email communication system, wherein the email communication system comprises an email template; and
customizably configuring the email communication system to interface the email template with at least one domain from the plurality of internet domain names, wherein the email template can interface with either the specific internet domain name, other domains from the plurality of internet domain names, or both the specific internet domain name and other domains from the plurality of internet domain names.
